(19) United States
(12) Patent Application Publication
(10) Pub. No.: US 2025/0266431 A1
(43) Pub. Date: Aug. 21, 2025

(54) CATHODE ACTIVE MATERIAL FOR LITHIUM SECONDARY BATTERY AND METHOD OF MANUFACTURING SAME

(71) Applicants: Hyundai Motor Company, Seoul (KR); Kia Corporation, Seoul (KR); Industry Academy Cooperation Foundation of Sejong University, Seoul (KR)

(72) Inventors: Eung Ju Lee, Daejeon (KR); Sung Ho Ban, Hwaseong (KR); Sang Hun Lee, Paju (KR); Chang Hoon Song, Seoul (KR); Tae Ho Park, Hwaseong (KR); Seung Tae Kim, Yongin (KR); Seung Min Oh, Incheon (KR); Ki Kang Lee, Hwaseong (KR); Hee Jae Kim, Seoul (KR); Jun Ho Yu, Seoul (KR); Chang-Heum Jo, Seoul (KR); ManJae Cho, Seoul (KR); Seung Taek Myung, Seoul (KR)

(21) Appl. No.: 18/800,971

(22) Filed: Aug. 12, 2024

(30) Foreign Application Priority Data
Feb. 21, 2024 (KR) 10-2024-0025167

(51) Int. Cl. H01M 4/36; H01M 4/02; H01M 4/04; H01M 4/58; H01M 4/583; H01M 4/62; H01M 10/052

(52) U.S. Cl. CPC H01M 4/366; H01M 4/0402; H01M 4/5825; H01M 4/583; H01M 4/625; H01M 10/052; H01M 2004/021; H01M 2004/028

(57) ABSTRACT

Disclosed is a cathode active material for a lithium secondary battery, including a first carbon coating layer formed on the surface of a core component containing lithium and configured to cover the core component and prevent dissolution of metal elements contained in the core component, and a second carbon coating layer formed on the surface of the first carbon coating layer and configured to have a lower carbon density and higher ionic conductivity than the first carbon coating layer.

### CROSS-REFERENCE TO THE RELATED APPLICATION(S)

This application claims the benefit of Korean Patent Application No. 10-2024-0025167, filed on Feb. 21, 2024, in the Korean Intellectual Property Office, the disclosure of which is incorporated herein by reference in its entirety.

### BACKGROUND

### Technical Field

The present disclosure relates to a cathode active material for a lithium secondary battery, including a first carbon coating layer formed on the surface of a core component containing lithium and configured to cover the core component and prevent the dissolution of metal elements contained in the core component. Additionally, a second carbon coating layer is formed on the surface of the first carbon coating layer. This second carbon coating layer has a lower carbon density and higher ionic conductivity than the first carbon coating layer.

### Background

Lithium secondary batteries have high energy density and lightweight characteristics, making them ideal power sources for small portable devices. Recently, lithium secondary batteries have been getting attention as power sources not only for small home appliances and mobile electronic devices, but also for hybrid/electric vehicles (HEV/EV), and other applications.

Generally, a cathode for a lithium secondary battery includes a cathode material, a conductor, a binder, and a current collector. In particular, a cathode material with excellent reversibility, low self-discharge rate, high capacity, and high energy density is required. Examples of a cathode active material that makes up the cathode material used in lithium secondary batteries include layered cathode active materials and phosphate-based cathode active materials. Layered cathode active materials, which have generally been used as cathode materials for existing lithium secondary batteries, have superior performance compared to phosphate-based cathode active materials and are employed as cathode materials for lithium secondary batteries.

Recently, however, there has been a growing demand for phosphate-based cathode active materials, which are relatively inexpensive compared to layered cathode active materials. These phosphate-based cathode active materials enable manufacture of low-cost cathodes and batteries due to the use of low-cost raw materials compared to layered cathode materials. However, they have the disadvantage of lower operating voltage and shorter lifespan characteristics.

### SUMMARY

The present disclosure addresses the problems encountered in the related art, with an object to provide a cathode active material for a lithium secondary battery, including a first carbon coating layer formed on the surface of a core component containing lithium and configured to cover the core component and prevent or reduce dissolution of metal elements contained in the core component, and a second carbon coating layer formed on the surface of the first carbon coating layer and configured to have a lower carbon density and higher ionic conductivity than the first carbon coating layer, and a method of manufacturing the same.

The technical objects to be achieved by the present disclosure are not limited to the foregoing, and other technical objects not mentioned herein are to be clearly understood by those skilled in the art from the following description.

In order to accomplish the above objects, the present disclosure provides a cathode active material for a lithium secondary battery, including a core component containing lithium, a first carbon coating layer formed on the surface of the core component and configured to cover the core component, and a second carbon coating layer formed on the surface of the first carbon coating layer and configured to have a lower carbon density and higher ionic conductivity than the first carbon coating layer.

For example, the core component may include a material represented by Chemical Formula 1 below.

Li(Fe_{1-x-y}MnₓM_{y})PO₄ [Chemical Formula 1]
wherein in formula 1: M includes any one or a mixture of two or more selected from the group consisting of Al, Mg, Y, Zn, In, Ru, Sn, Sb, Ti, Te, Nb, Mo, Cr, Zr, W, Ir, and V; 0≤x≤0.9; and 0≤y≤0.1.

For example, the second carbon coating layer may cover 30% to 70% of the surface of the core component with the first carbon coating layer formed thereon. In another aspect, the second carbon coating layer may cover 10%, 20%, 30% or 40% to 60%, 70%, 80% or 90% of the surface of the core component with the first carbon coating layer formed thereon

For example, the thickness of the second carbon coating layer may be 100 to 500 nm.

For example, the amount of the second carbon coating layer may be 5 to 7 wt % based on a total of 100 wt % of the cathode active material.

For example, the second carbon coating layer may include a conductive material that increases electrical conductivity.

For example, the conductive material may be at least one selected from the group consisting of conductive materials including carbon black, CNTs, and mixtures thereof.

For example, the cathode active material may have a D/G ratio of 0.9 or more as measured by Raman spectroscopy.

In addition, the present disclosure provides a method of manufacturing a cathode active material for a lithium secondary battery, including forming a core component containing lithium, forming a first carbon coating layer on the surface of the core component, and forming a second carbon coating layer having a lower carbon density than the first carbon coating layer on the surface of the first carbon coating layer.

For example, a sol-gel method may be used in forming the core component and forming the first carbon coating layer, and the pH of a solvent in the sol-gel method may be 2 to 3.

In forming the first carbon coating layer, a first carbon coating solution in which at least one organic material selected from the group consisting of organic materials including sucrose, grape sugar, glucose, PEG2000, PEG6000, white sugar, and mixtures thereof is dissolved may be added to a solvent in a sol-gel method.

For example, the sucrose material may be contained at a concentration of 0.1 to 0.2 M in the first carbon coating solution.

For example, in forming the second carbon coating layer, pitch may be added in an amount of 5 to 7 wt % based on a total of 100 wt % of the cathode active material.

For example, in forming the second carbon coating layer, at least one selected from the group consisting of conductive materials including carbon black, CNTs, and mixtures thereof may be added.

For example, forming the second carbon coating layer may include adding the core component with the first carbon coating layer formed thereon, pitch carbon, and a conductive material to ethanol and performing milling.

For example, in forming the second carbon coating layer, heat treatment may be performed at 660 to 700° C. for 9 to 10 hours.

In addition, the present disclosure provides an electrode for a lithium secondary battery including the cathode active material described above.

In addition, the present disclosure provides a lithium secondary battery including the cathode active material described above.

In a further aspect, vehicles are provided that comprise a lithium secondary battery as disclosed herein.

Other aspects are disclosed infra.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 schematically shows a cathode active material for a lithium secondary battery according to the present disclosure;

FIG. 2 shows an SEM image of the surface of a core component before formation of a first carbon coating layer;

FIG. 3 shows an SEM image of the cross-section of the core component before formation of the first carbon coating layer;

FIG. 4 and FIG. 5 show SEM images of the surface of the core component with the first carbon coating layer formed thereon;

FIG. 6 shows an SEM image of the cross-section of the core component with the first carbon coating layer formed thereon;

FIG. 7 and FIG. 8 show SEM images of the surface of the core component with the first and second carbon coating layers formed thereon;

FIG. 9 shows an SEM image of the cross-section of the core component with the first and second carbon coating layers formed thereon;

FIG. 10 is a flowchart showing a process of manufacturing a cathode active material for a lithium secondary battery according to an embodiment of the present disclosure;

FIG. 11 is a graph showing results of measurement of voltage of Examples 1 to 3 and Comparative Examples 1 and 2 (LiFe_{0.75}Mn_{0.25}PO₄);

FIG. 12 is a graph showing results of measurement of voltage of Examples 1 to 3 and Comparative Examples 1 and 2 (LiFe_{0.50}Mn_{0.50}PO₄);

FIG. 13 is a graph showing results of measurement of voltage of Examples 1 and 4 and Comparative Examples 3 to 5;

FIG. 14 is a graph showing results of measurement of voltage of Examples 1 and 5 and Comparative Examples 6 and 7;

FIG. 15 is a graph showing results of measurement of discharge capacity depending on the charge/discharge cycles of Examples 1 and 5 and Comparative Examples 6 and 7;

FIG. 16 is a graph showing results of measurement of capacity retention depending on the charge/discharge cycles of Examples 1 and 5 and Comparative Examples 6 and 7; and

FIG. 17 is a graph showing results of measurement of voltage of Examples 1 and 6 and Comparative Examples 8 and 9.

### DETAILED DESCRIPTION

Terms or words used in the specification and claims should not be construed as limited to their ordinary or dictionary meanings, and should be interpreted as having meanings and concepts consistent with the technical idea of the present disclosure based on the principle that the inventor may appropriately define the concept of terms in order to explain the disclosure in the best way.

The terms used herein are used only to describe exemplary embodiments and are not intended to limit the present disclosure. Singular expressions encompass the plural expressions unless the context clearly dictates otherwise.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Herein, carbon density may refer to the number or density of carbon atoms present in a specific unit area or space. For example, if the carbon density of the second carbon coating layer 300 is lower than that of the first carbon coating layer, it means that the number of carbon atoms present per unit area or volume of the second carbon coating layer 300 is less than that in the first carbon coating layer.

A sol-gel method is a method of preparing a solid oxide by gelling a solution of organic and inorganic metal compounds and heat-treating the same, and enables the preparation of powders, fibers, thin films, and bulk materials through ultra-fine structural adjustment capable of controlling the molecular structure. In the sol-gel method, a uniformly dispersed suspension-type sol without precipitation is converted into a gel with no fluidity by removal of a solvent and organic material.

X-ray diffraction (XRD) is a method of non-destructively obtaining detailed phase and structural information from a material sample. By measuring the diffraction angle of the primary X-ray beam according to Bragg's law, various chemical materials, topologies, and structures in the sample may be characterized and identified in the sample. This method is effective at determining the structure of polycrystalline materials and measurement and analysis are possible using an EQUINOX 100 Diffractometer from ThermoFisher Scientific Inc., as well as other instruments commonly used in the field.

Raman spectroscopy uses the Raman effect. When a laser is applied to a specific molecule, the surface state of the molecule is measured based on a phenomenon of absorbing energy equal to the difference in the energy level of the molecule's electrons, thereby determining the extent of crushing of the sample. Specifically, a Raman spectrometer (ReactRaman 802L, METTLER TOLEDO, Inc.) may be used.

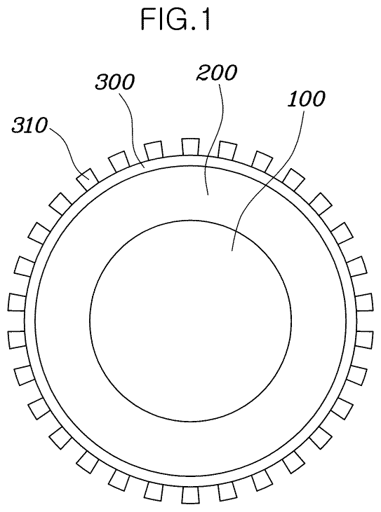

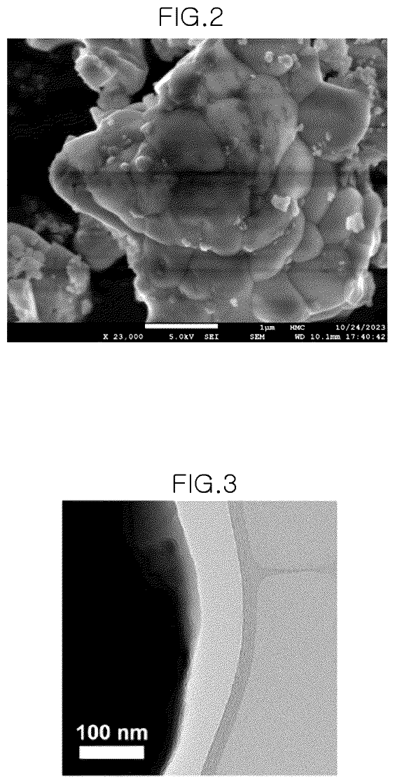

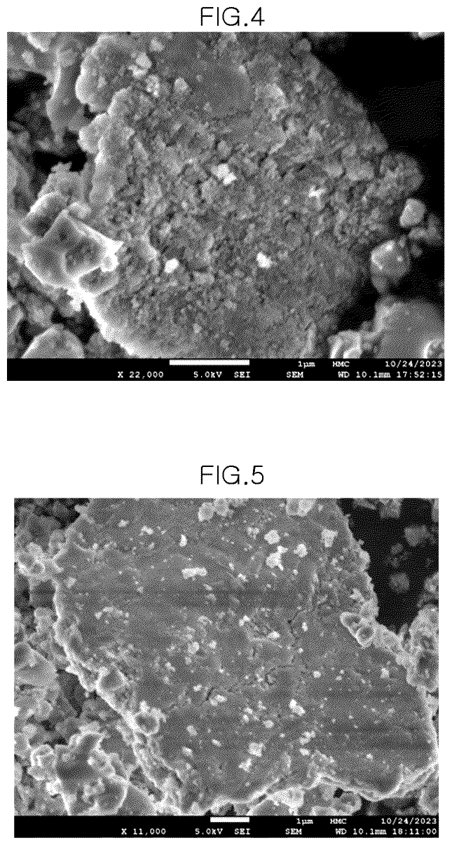

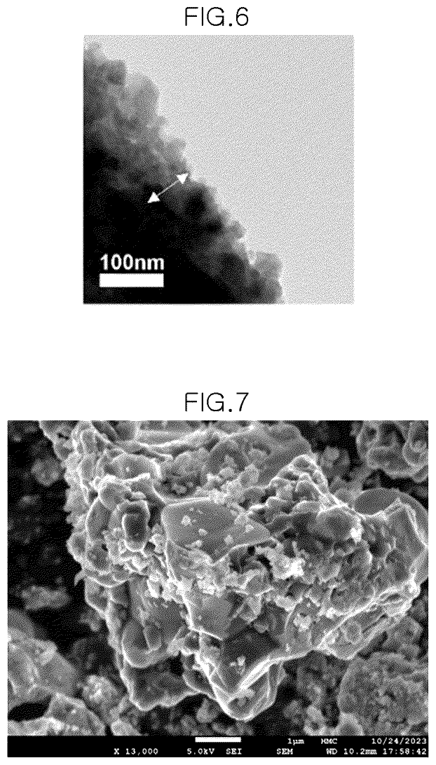

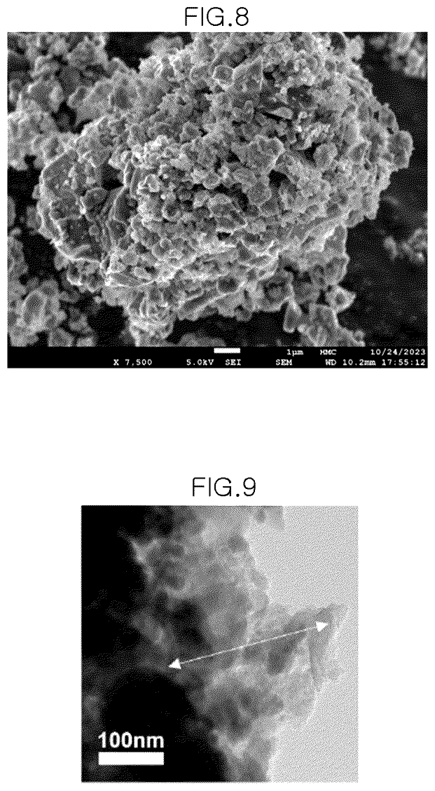

An embodiment of the present disclosure pertains to a cathode active material for a lithium secondary battery, including a first carbon coating layer 200 formed on the surface of a core component 100 containing lithium and configured to cover the core component 100 and prevent dissolution of metal elements contained in the core component 100, and a second carbon coating layer 300 formed on the surface of the first carbon coating layer 200 and configured to have a lower carbon density and higher ionic conductivity than the first carbon coating layer 200. FIG. 1 schematically shows a cathode active material for a lithium secondary battery according to an embodiment of the present disclosure, FIG. 2 shows an SEM image of the surface of the core component 100 before formation of the first carbon coating layer 200, FIG. 3 shows an SEM image of the cross-section of the core component 100 before formation of the first carbon coating layer 200, FIG. 4 and FIG. 5 show SEM images of the surface of the core component 100 with the first carbon coating layer 200 formed thereon, FIG. 6 shows an SEM image of the cross-section of the core component 100 with the first carbon coating layer 200 formed thereon, FIG. 7 and FIG. 8 show SEM images of the surface of the core component 100 with the first and second carbon coating layers formed thereon, and FIG. 9 shows an SEM image of the cross-section of the core component 100 with the first and second carbon coating layers formed thereon. Referring thereto, the cathode active material for a lithium secondary battery according to the present disclosure is described below.

The cathode active material for a lithium secondary battery according to the present disclosure includes a core component 100 containing lithium, a first carbon coating layer 200 formed on the surface of the core component 100 and configured to cover the core component 100 and prevent dissolution of metal elements contained in the core component 100, and a second carbon coating layer 300 formed on the surface of the first carbon coating layer 200 and configured to have a lower carbon density and higher ionic conductivity than the first carbon coating layer 200.

Here, carbon density may refer to the number or density of carbon atoms present in a specific unit area or space. For example, if the carbon density of the second carbon coating layer 300 is lower than that of the first carbon coating layer 200, it means that the number of carbon atoms present per unit area or volume of the second carbon coating layer 300 is less than the number of carbon atoms present per unit area or volume of the first carbon coating layer 200. The core component 100 may contain lithium, and the core component 100 may include a material represented by Chemical Formula 1 below.

Li(Fe_{1※y}MnₓM_{y})PO₄ [Chemical Formula 1]

Here, M may include any one or a mixture of two or more selected from the group consisting of Al, Mg, Y, Zn, In, Ru, Sn, Sb, Ti, Te, Nb, Mo, Cr, Zr, W, Ir, and V, 0≤x≤0.9, and 0≤y≤0.1.

FIG. 2 shows an SEM image of the surface of the core component 100 before formation of the first carbon coating layer 200, and FIG. 3 shows an SEM image of the cross-section of the core component 100 before formation of the first carbon coating layer 200.

The first carbon coating layer 200 may cover 70 to 100% of the surface of the core component 100, and the thickness of the first carbon coating layer 200 may be 10 to 50 nm.

If the thickness tis less than the above lower limit, it may be difficult to effectively prevent dissolution of metal elements such as Mn contained in the core component 100. Conversely, if the thickness exceeds the upper limit, the exchange of lithium and other metal elements in the core component 100, as well as the ionic conductivity, may be reduced.

The first carbon coating layer 200 may be formed by heat-treating at least one organic material selected from the group consisting of organic materials including sucrose, grape sugar, glucose, PEG2000, PEG6000, white sugar, and mixtures thereof.

FIG. 4 and FIG. 5 show SEM images of the surface of the core component 100 with the first carbon coating layer 200 formed thereon, and FIG. 6 shows an SEM image of the cross-section of the core component 100 with the first carbon coating layer 200 formed thereon.

Additionally, the second carbon coating layer 300 may cover 30 to 70% of the surface of the core component 100 with the first carbon coating layer 200 formed thereon, and the thickness of the second carbon coating layer 300 may be 100 to 500 nm.

If the thickness thereof is less than the above lower limit, it may be difficult to effectively prevent dissolution of metal elements such as Mn, etc. contained in the core component 100, whereas if the thickness thereof exceeds the above upper limit, exchange of the core component 100 and the metal elements such as lithium, etc. and ionic conductivity may be lowered.

The amount of the second carbon coating layer 300 may be 5 to 7 wt % based on a total of 100 wt % of the cathode active material. If the amount is less than the above lower limit, it may be difficult to effectively prevent dissolution of metal elements such as Mn contained in the core component 100. Conversely, if the amount exceeds the above upper limit, the exchange of lithium and other metal elements in the core component 100, as well as the ionic conductivity, may be reduced.

The second carbon coating layer 300 may be formed by heat-treating a material including pitch.

Also, the second carbon coating layer 300 may include a conductive material 310 that increases electrical conductivity, and the conductive material 310 may be at least one selected from the group consisting of conductive materials including carbon black, CNTs, and mixtures thereof.

Furthermore, the cathode active material for a lithium secondary battery according to the present disclosure may have a D/G ratio of 0.9 or higher as measured by Raman spectroscopy.

FIG. 7 and FIG. 8 show SEM images of the surface of the core component 100 with the first and second carbon coating layers formed thereon, and FIG. 9 shows an SEM image of the cross-section of the core component 100 with the first and second carbon coating layers formed thereon.

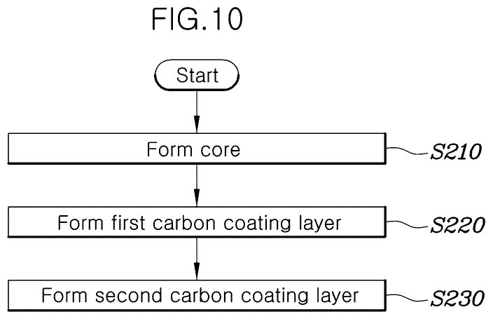

FIG. 10 is a flowchart showing a process of manufacturing a cathode active material for a lithium secondary battery according to an embodiment of the present disclosure. Referring thereto, the method of manufacturing a cathode active material for a lithium secondary battery according to the present disclosure is described below.

First, forming a core component containing lithium may be performed (S210).

A sol-gel method may be used in forming the core component 100 and forming a first carbon coating layer 200.

Specifically, LiH₂PO₄ as a metal material, a transition metal material, and citric acid and sucrose may be added at a molar ratio of 1:0.2:0.2 to deionized water and stirred. As such, Fe and Mn as transition metals may be added at a molar ratio of 75:25. The pH of the solution may be adjusted by adding an ammonia solution. The solution may be dried at 95° C. (laboratory stirrer temperature indicated: 250° C.) at a speed of 1000 rpm until a gel with high viscosity is formed. Thereafter, the gel may be placed in a box furnace heated to 200° C. and completely dried.

Thereafter, a powder may be collected by tapping the container containing the dried powder, followed by pretreatment through heating in a furnace to a temperature range of 300 to 500° C.

As such, the pH of the solvent in the sol-gel method may be 1 to 7, preferably 2 to 3.

As confirmed in the Test Examples described later, when the pH of the solvent in the sol-gel method falls in the corresponding range, the core component 100 may be provided in the form of particles having a uniform size of about 70-100 nm. In addition, if the pH thereof is around 1 or less than 1, particles may be formed in irregular sizes, whereas if the pH thereof is above 3, agglomeration of particles may become more severe.

Next, forming a first carbon coating layer on the surface of the core component may be performed (S220).

As such, formation of the first carbon coating layer 200 may prevent excessive dissolution of metal elements of the core component 100.

The sol-gel method may be used as described above in forming the core component 100 and forming the first carbon coating layer 200.

As such, in forming the first carbon coating layer 200, at least one organic material selected from the group consisting of organic materials including sucrose, grape sugar, glucose, PEG2000, PEG6000, white sugar, and mixtures thereof may be added to the solvent in the sol-gel method.

The organic material may be contained at a concentration of 0.1 to 0.2 M in the first carbon coating solution. As confirmed in the Test Examples described later, if the concentration thereof is less than the above lower limit, formation of the first carbon coating layer 200 may be insufficient, whereas if the concentration thereof exceeds the above upper limit, process efficiency may decrease during pretreatment after the sol-gel method, and electrochemical performance may be also very poor.

Next, forming a second carbon coating layer 300 with a lower carbon density than the first carbon coating layer 200 on the surface of the first carbon coating layer 200 may be performed (S230).

As such, carbon density may indicate the number or density of carbon atoms present in a specific unit area or space. For example, the carbon density of the second carbon coating layer 300 being lower than that of the first carbon coating layer 200 means that the number of carbon atoms present per unit area or volume of the second carbon coating layer 300 is less than the number of carbon atoms present per unit area or volume of the first carbon coating layer 200.

For example, forming the second carbon coating layer 300 may include adding the core component 100 with the first carbon coating layer 200 formed thereon, pitch carbon, and a conductive material 310 to ethanol and milling the same. Specifically, the pretreated powder, pitch carbon, and conductive material (Denka black) may be added to ethanol and milled for 1 hour at a speed of 300 rpm. Thereafter, the milled powder may be dried in a convection oven at 200° C. Subsequently, the dried powder may be heat-treated at a temperature of 680° C. for 10 hours in an argon/hydrogen 4% atmosphere. Thereafter, the heat-treated powder may be added to ethanol and then milled at a speed of 300 rpm for 1 hour.

As such, in forming the second carbon coating layer 300, the pitch may be added in an amount of 5 to 7 wt % based on a total of 100 wt % of the cathode active material. As confirmed in the Test Examples described later, if the amount thereof is less than the above lower limit, formation of the second carbon coating layer 300 may be insufficient, whereas if the amount thereof exceeds the above upper limit, the volume ratio and weight ratio of the core component 100 relative to the cathode active material may be reduced, which may cause a decrease in energy density.

As such, in forming the second carbon coating layer 300, the reason why the core component 100 with the first carbon coating layer 200 formed thereon, the pitch carbon, and the conductive material 310 are added to ethanol and then milled is that ethanol has low pitch solubility and a short evaporation time. This provides superior conditions in view of environmental issues and manufacturing costs, compared to NMP, which dissolves almost all of the pitch, has a considerably long evaporation time and causes environmental problems and THF, which dissolves almost all of the pitch, has a fairly short evaporation time but has environmental problems and very poor material performance.

Also, in forming the second carbon coating layer 300, at least one selected from the group consisting of conductive materials including carbon black, CNTs, and mixtures thereof may be added. This can increase the electrical conductivity of the cathode active material according to the present disclosure.

In forming the second carbon coating layer 300, heat treatment may be performed at a temperature of 660 to 700° C. for 9 to 11 hours.

As confirmed in the Test Examples described later, if the heat treatment temperature is less than the above lower limit, the extent of densification of the cathode active material particles may be insufficient and the extent of carbonization of the first carbon coating layer 200 may be insufficient, whereas if the heat treatment temperature exceeds the above upper limit, the cathode active material particles may be enlarged and changes in surface structure may occur.

Another embodiment of the present disclosure pertains to a lithium secondary battery including a cathode including the cathode active material for a lithium secondary battery according to the present disclosure, an anode including an anode active material, and an electrolyte solution of the present disclosure.

Specifically, the lithium secondary battery according to the present disclosure may be manufactured by injecting a non-aqueous electrolyte solution of the present disclosure into an electrode structure composed of a cathode, an anode, and a separator interposed between the cathode and the anode. As such, the cathode, the anode, and the separator that make up the electrode structure may all be those commonly used in manufacturing lithium secondary batteries. These components are described below.

### <Anode>

An anode active material may be formed using materials that may deintercalate lithium ions or cause conversion reaction.

An anode material may be obtained by mixing an anode active material, a conductive material, and a binder.

An anode may be formed by applying the anode material onto a anode current collector. The anode current collector may be a conductor. Applying the anode material onto the anode current collector may be carried out by press-forming or by subjecting a paste prepared using an organic solvent to application onto a current collector, pressing, and fixation.

### <Electrolyte>

The electrolyte may include lithium. Also, an electrolyte containing fluorine may be used. Also, the electrolyte may be dissolved in an organic solvent and used as a non-aqueous electrolyte solution. Alternatively, a solid electrolyte may be used. Also, there are cases in which the solid electrolyte acts as a separator, which will be described below, and as such, there are cases in which a separator is not required.

### <Separator>

A separator may be interposed between the cathode and the anode. This separator may be a material in the form of a porous film, a nonwoven fabric, or a woven fabric. The separator is preferably thinner so long as mechanical strength is maintained in view of increasing the volumetric energy density of the battery and decreasing internal resistance.

### <Method of Manufacturing Lithium Secondary Battery>

A lithium secondary battery may be manufactured by sequentially stacking a cathode, a separator, and an anode to form an electrode group, then rolling up the electrode group as necessary, storing the same in a battery can, and impregnating the electrode group with a non-aqueous electrolyte solution. Alternatively, a secondary battery may be manufactured by stacking a cathode, a solid electrolyte, and an anode to form an electrode group, then rolling up the electrode group and storing the same in a battery can, as necessary.

A better understanding of the present disclosure may be obtained through the following examples. However, these examples are merely set forth to illustrate the present disclosure, and are not to be construed as limiting the present disclosure.

### EXAMPLES AND COMPARATIVE EXAMPLES

### Example 1

### (1) Formation of Core Component and First Carbon Coating Layer

LiH₂PO₄, Mn nitrate, Fe nitrate, citric acid, sucrose, and an ammonia solution were prepared.

A first carbon coating solution in which LiH₂PO₄ as a metal material, a transition metal material, and citric acid and sucrose were dissolved was added to deionized water and stirred. As such, the concentration of sucrose in the first carbon coating solution was 0.1 M.

As such, Fe and Mn as transition metals were added at a molar ratio of 75:25.

To adjust the pH of the solution, an ammonia solution was added to raise the pH to 2.

The solution was sufficiently stirred at 1000 rpm and 95° C. The solution was dried until a gel with high viscosity was formed, and was then placed in a box furnace heated to 200° C. and completely dried.

After collecting a powder by tapping a container containing the dried powder, pretreatment was performed by heating the furnace to 400° C.

### (2) Formation of Second Carbon Coating Layer

The pretreated powder, pitch carbon, and conductive material (Denka black) were added to ethanol and milled at a speed of 300 rpm for 1 hour. As such, the amount of the pitch forming the second carbon coating layer was 5 wt % based on a total of 100 wt % of the cathode active material.

The milled powder was dried in a convection oven at 200° C.

### (3) Heat Treatment

The dried powder was heat-treated at 680° C. for 10 hours in an argon/hydrogen 4% atmosphere. Thereafter, ethanol was added to the heat-treated powder, and the powder was milled at a speed of 300 rpm for 1 hour, thereby manufacturing a cathode active material for a lithium secondary battery.

### Example 2

A cathode active material for a lithium secondary battery was manufactured under the same conditions as in Example 1, with the exception that heat treatment was performed at 660° C. in the heat treatment step.

### Example 3

A cathode active material for a lithium secondary battery was manufactured under the same conditions as in Example 1, with the exception that heat treatment was performed at 700° C. in the heat treatment step.

### Example 4

A cathode active material for a lithium secondary battery was manufactured under the same conditions as in Example 1, with the exception that the concentration of sucrose in the first carbon coating solution was 0.2 M in forming the core component and forming the first carbon coating layer.

### Example 5

A cathode active material for a lithium secondary battery was manufactured under the same conditions as in Example 1, with the exception that the amount of the pitch forming the second carbon coating layer was 7 wt % based on a total of 100 wt % of the cathode active material in forming the second carbon coating layer.

### Example 6

A cathode active material for a lithium secondary battery was manufactured under the same conditions as in Example 1, with the exception that the pH of the solution was adjusted to 3 in forming the core component and forming the first carbon coating layer.

### Comparative Example 1

A cathode active material for a lithium secondary battery was manufactured under the same conditions as in Example 1, with the exception that heat treatment was performed at 640° C. in the heat treatment step.

### Comparative Example 2

A cathode active material for a lithium secondary battery was manufactured under the same conditions as in Example 1, with the exception that heat treatment was performed at 720° C. in the heat treatment step.

### Comparative Example 3

A cathode active material for a lithium secondary battery was manufactured under the same conditions as in Example 1, with the exception that the concentration of sucrose in the first carbon coating solution was 0.05 M in forming the core component and forming the first carbon coating layer.

### Comparative Example 4

A cathode active material for a lithium secondary battery was manufactured under the same conditions as in Example 1, with the exception that the concentration of sucrose in the first carbon coating solution was 0.5 M in forming the core component and forming the first carbon coating layer.

### Comparative Example 5

A cathode active material for a lithium secondary battery was manufactured under the same conditions as in Example 1, with the exception that the concentration of sucrose in the first carbon coating solution was 0.8 M in forming the core component and forming the first carbon coating layer.

### Comparative Example 6

A cathode active material for a lithium secondary battery was manufactured under the same conditions as in Example 1, with the exception that the pitch was not added (0 wt %) in forming the second carbon coating layer.

### Comparative Example 7

A cathode active material for a lithium secondary battery was manufactured under the same conditions as in Example 1, with the exception that the amount of the pitch forming the second carbon coating layer was 3 wt % based on a total of 100 wt % of the cathode active material in forming the second carbon coating layer.

### Comparative Example 8

A cathode active material for a lithium secondary battery was manufactured under the same conditions as in Example 1, with the exception that the pH of the solution was adjusted to 1 in forming the core component and forming the first carbon coating layer.

### Comparative Example 9

A cathode active material for a lithium secondary battery was manufactured under the same conditions as in Example 1, with the exception that the pH of the solution was adjusted to 7 in forming the core component and forming the first carbon coating layer.

### Test Examples

### (1) SEM Imaging

The surface and cross-section of the core component before formation of the first carbon coating layer of the present disclosure, the surface and cross-section of the core component after formation of the first carbon coating layer, and the surface and cross-section of the cathode active material after formation of the first carbon coating layer and the second carbon coating layer were observed.

As such, FIG. 2 shows an SEM image of the surface of the core component before formation of the first carbon coating layer, FIG. 3 shows an SEM image of the cross-section of the core component before formation of the first carbon coating layer, FIG. 4 and FIG. 5 show SEM images of the surface of the core component with the first carbon coating layer formed thereon, FIG. 6 shows an SEM image of the cross-section of the core component with the first carbon coating layer formed thereon, FIG. 7 and FIG. 8 show SEM images of the surface of the core component with the first carbon coating layer and the second carbon coating layer formed thereon, and FIG. 9 shows an SEM image of the cross-section of the core component with the first carbon coating layer and the second carbon coating layer formed thereon.

Thus, it was confirmed that the first carbon coating layer and the second carbon coating layer were effectively formed on the surface of the core component by the method of manufacturing a cathode active material for a lithium secondary battery according to the present disclosure.

In addition, as shown in FIG. 4, the first carbon coating layer was confirmed to cover about 70% of the surface of the core component, and to cover about 100% thereof as shown in FIG. 5, and as shown in FIG. 6, the thickness of the first carbon coating layer was determined to be 10 to 50 nm.

Also, as shown in FIG. 7, the second carbon coating layer was confirmed to cover about 30% of the surface of the core component with the first carbon coating layer formed thereon, and to cover about 70% of the surface of the core component with the first carbon coating layer formed thereon as shown in FIG. 8.

Additionally, as shown in FIG. 9, the thickness of the second carbon coating layer was determined to be 100 to 500 nm.

### (2) Electrode and Battery Fabrication

### Electrode Fabrication

10 g of NMP and 4.8 g of a cathode active material (cathode to conductive material to binder=90:6:4) were added to a 2% PVdF solution and stirred. As such, stirring was repeated three times for 20 minutes at a stirring speed of 2000 rpm to obtain a slurry. The slurry was applied onto aluminum foil and cast with a doctor blade. As such, the wet thickness was 150 μm excluding the foil. Thereafter, drying in a convection oven at 120° C., sequential compression to 30 μm using a press with a pressure of 2 tons, and drying in a vacuum oven at 100° C. for one day were performed.

### Battery Fabrication

An electrolyte (1 M LiPF₆ in EC:DEC at 7:3), lithium metal, a separator (alumina coated PP), and a cathode were prepared. The bottom cap of a battery was placed and the cathode was placed thereon. 20 μl of the electrolyte was added thereto, and the separator was then placed thereon. After fixing the separator with a gasket, 80 μl of the electrolyte was added thereto. A current collector with lithium metal attached thereto was placed thereon, and a spring was placed thereon, followed by covering with a top cap and cell binding to manufacture a coin battery. For stabilization, the battery thus manufactured was stored at room temperature for half a day.

### (3) Measurement of Voltage

The battery manufactured by the method in (1) was charged and discharged at a constant current in the potential range of 2.5 V to 4.5 V using a constant current method.

### (4) Measurement of Initial Capacity and Initial Efficiency

The battery manufactured by the method in (1) was subjected to one cycle of constant current charging at a current of 0.1 C, cut-off at a current of 0.1 C, constant voltage charging at 4.5 V, then constant current discharging at a current of 0.1 C, cut-off at a current of 0.1 C, and constant voltage discharging at 2.5 V.

As such, the initial capacity was determined by measuring discharge capacity after completion of constant voltage discharging at 0.1 C, and the initial efficiency was determined using Equation 1 below.

Initial efficiency=[Discharge capacity after completion of constant voltage discharging at 0.1 C/charge capacity after completion of constant voltage charging at 0.1 C] [Equation 1]

### (5) Measurement of Rate Capability

Continuous measurement was performed on the battery subjected to measurement of the initial capacity and initial efficiency.

One cycle of constant current charging at a current of 0.2 C, cut-off at a current of 0.2 C, constant voltage charging at 4.5 V, then constant current discharging at a current of 0.2 C, cut-off at a current of 0.2 C, and constant voltage discharging at 2.5 V was performed.

One cycle of constant current charging at a current of 0.5 C, cut-off at a current of 0.5 C, constant voltage charging at 4.5 V, then constant current discharging at a current of 0.5 C, cut-off at a current of 0.5 C, and constant voltage discharging at 2.5 V was performed.

One cycle of constant current charging at a current of 1.0 C, cut-off at a current of 1.0 C, constant voltage charging at 4.5 V, then constant current discharging at a current of 1.0 C, cut-off at a current of 1.0 C, and constant voltage discharging at 2.5 V was performed.

One cycle of constant current charging at a current of 2.0 C, cut-off at a current of 2.0 C, constant voltage charging at 4.5 V, then constant current discharging at a current of 2.0 C, cut-off at a current of 2.0 C, and constant voltage discharging at 2.5 V was performed. Rate capability was determined using Equation 2 below.

Rate capability=[Discharge capacity after completion of constant voltage discharging at measured rate/discharge capacity after completion of constant voltage discharging at 0.1 C] [Equation 2]

### (6) Measurement of Recovery Capacity

The battery for which measurement of rate capability had been completed was subjected to one cycle of constant current charging at a current of 0.1 C, cut-off at a current of 0.1 C, constant voltage charging at 4.5 V, then constant current discharging at a current of 0.1 C, cut-off at a current of 0.1 C, and constant voltage discharging at 2.5 V, and recovery capacity thereof was measured.

### (7) Measurement of Lifespan Characteristics

The battery for which measurement of recovery capacity had been completed was subjected to 50 cycles of constant current charging at a current of 0.5 C, cut-off at a current of 0.5 C, constant voltage charging at 4.5 V, then constant current discharging at a current of 0.5 C, cut-off at a current of 0.5 C, and constant voltage discharging at 2.5 V.

The lifespan characteristics were determined using Equation 3 below.

Capacity retention=[Discharge capacity after 50 charge/discharge cycles/discharge capacity after 1 charge/discharge cycle] [Equation 3]

### (8) Evaluation of Battery Performance Depending on Heat Treatment Temperature

### [Table 1]

TABLE 1

| | Firing | Fe:Mn = 75:25 | Fe:Mn = 50:50 |
|---|---|---|---|
| | temperature | Discharge capacity | Discharge capacity |
| | (° C.) | (mAh/g) | (mAh/g) |
| Comparative | 720 | 125.6 | 102.1 |
| Example 2 | | | |
| Example 3 | 700 | 125.1 | 103.4 |
| Example 1 | 680 | 146.7 | 117.3 |
| Example 2 | 660 | 132.27 | 108.61 |
| Comparative | 640 | 127.17 | 99.55 |
| Example 1 | | | |

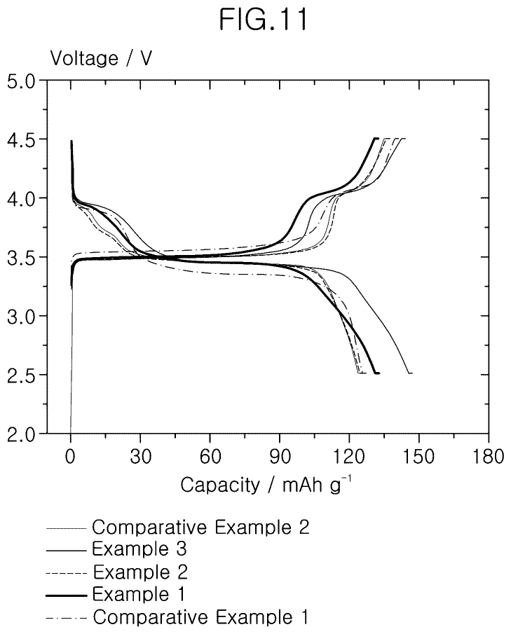

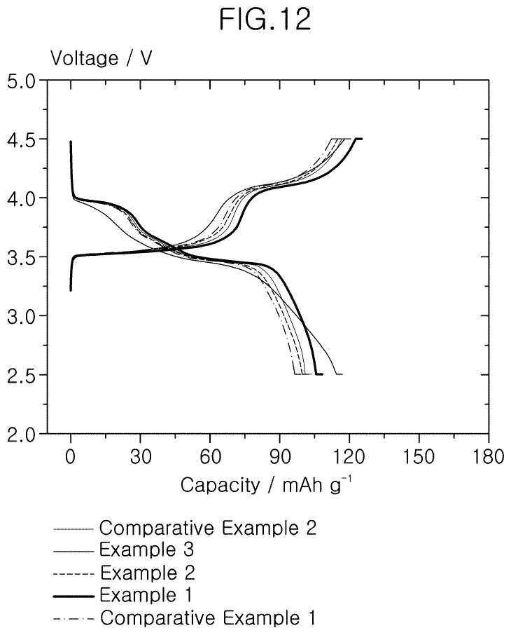

FIG. 11 is a graph showing results of measurement of voltage of Examples 1 to 3 and Comparative Examples 1 and 2 (LiFe_{0.75}Mn_{0.25}PO₄), and FIG. 12 is a graph showing results of measurement of voltage of Examples 1 to 3 and Comparative Examples 1 and 2 (LiFe_{0.50}Mn_{0.50}PO₄). Table 1 shows the discharge capacity depending on the firing temperature for Examples 1 to 3 and Comparative Examples 1 and 2. Referring to FIG. 11 and FIG. 12 and Table 1, it was confirmed that Example 1, in which the firing temperature was 680° C., had the best discharge capacity and voltage performance in both LiFe_{0.75}Mn_{0.25}PO₄ and LiFe_{0.50}Mn_{0.50}PO₄. Additionally, when comparing Examples 1 to 3 with Comparative Examples 1 and 2, discharge capacity and voltage performance decreased with an increase or a decrease in the firing temperature based on the firing temperature of 680° C. Thus, it was confirmed that the best discharge capacity and voltage performance were achieved at a firing temperature of 660 to 700° C., preferably 680° C.

### (9) Evaluation of Battery Performance Depending on Concentration of Sucrose

[Table 2]

TABLE 2

| | Concentration | Discharge |
|---|---|---|
| | of sucrose | capacity (mAh/g) |
| Comparative Example 3 | 0.05M | 126.12 |
| Example 1 | 0.1M | 145.91 |
| Example 4 | 0.2M | 146.7 |
| Comparative Example 4 | 0.5M | 76.5 |
| Comparative Example 5 | 0.8M | 71.8 |

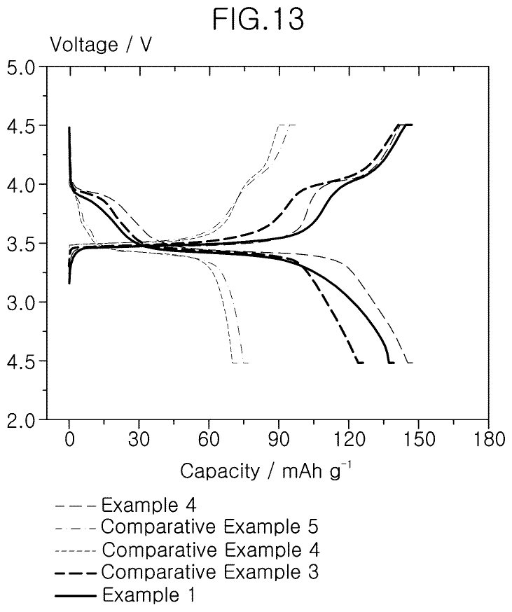

FIG. 13 is a graph showing results of measurement of voltage of Examples 1 and 4 and Comparative Examples 3 to 5, and Table 2 shows discharge capacity depending on the concentration (M) of sucrose of Examples 1 and 4 and Comparative Examples 3 to 5. Referring to FIG. 13 and Table 2, it was confirmed that Example 1 with 0.1 M sucrose and Example 4 with 0.2 M sucrose had excellent discharge capacity and voltage performance.

Additionally, when comparing Examples 1 and 4 with Comparative Examples 3 to 5, the discharge capacity decreased with an increase or a decrease in the concentration of sucrose outside the range of 0.1 to 0.2 M. This confirmed that the best discharge capacity and voltage performance were achieved when the concentration of sucrose was in the range of 0.1 to 0.2 M.

### (10) Evaluation of Battery Performance Depending on Amount of Pitch

### [Table 3]

TABLE 3

| | Amount of | Discharge | Lifespan |
|---|---|---|---|
| | pitch | capacity | maintenance |
| | (wt %) | (mAh g⁻¹) | (%, 50 cycles) |
| Comparative Example 6 | 0 | 146.7 | 92.30 |
| Comparative Example 7 | 3 | 145.42 | 94.45 |
| Example 1 | 5 | 159.9 | 98.16 |
| Example 5 | 7 | 146.48 | 100.69 |

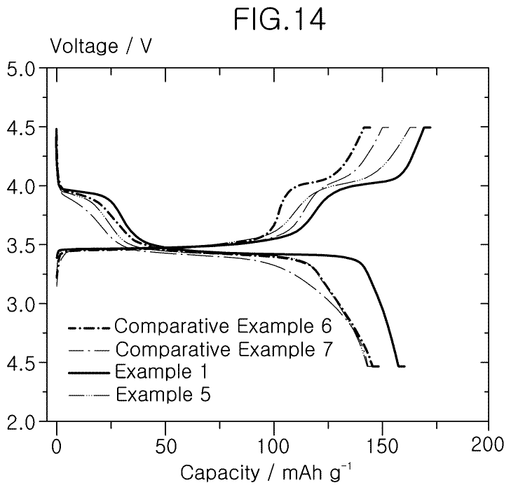

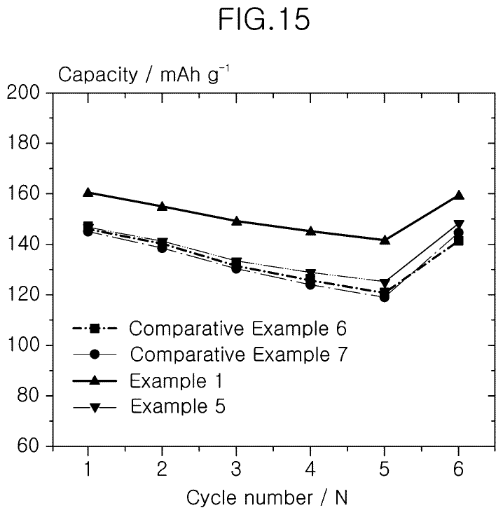

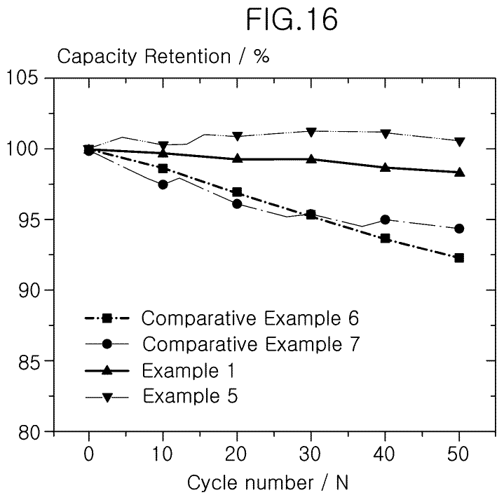

FIG. 14 is a graph showing results of measurement of voltage of Examples 1 and 5 and Comparative Examples 6 and 7, FIG. 15 is a graph showing results of measurement of discharge capacity depending on the charge/discharge cycles of Examples 1 and 5 and Comparative Examples 6 and 7, FIG. 16 is a graph showing results of measurement of capacity retention depending on the charge/discharge cycles of Examples 1 and 5 and Comparative Examples 6 and 7, and Table 3 shows discharge capacity and lifespan maintenance depending on the amount (wt %) of the pitch based on the total amount of the cathode active material in Examples 1 and 5 and Comparative Examples 6 and 7. Referring to FIG. 14 to FIG. 16 and Table 3, it was confirmed that Example 1 with 5 wt % of the pitch and Example 5 with 7 wt % of the pitch had excellent discharge capacity, lifespan maintenance, and voltage performance.

Additionally, when comparing Examples 1 and 5 with Comparative Examples 6 and 7, discharge capacity, lifespan maintenance, and voltage performance decreased with an increase or a decrease in the amount of the pitch outside the range of 5 to 7 wt %. This confirmed that excellent discharge capacity, lifespan maintenance, and voltage performance were achieved when the amount of the pitch was in the range of 5 to 7 wt %.

### (11) Evaluation of Battery Performance Depending on pH

TABLE 4

| | | Discharge |
|---|---|---|
| | pH of solution | capacity (mAh/g) |
| Comparative Example 8 | 1 | 134.3 |
| Example 1 | 2 | 159.9 |
| Example 6 | 3 | 136.0 |
| Comparative Example 9 | 7 | 124.7 |

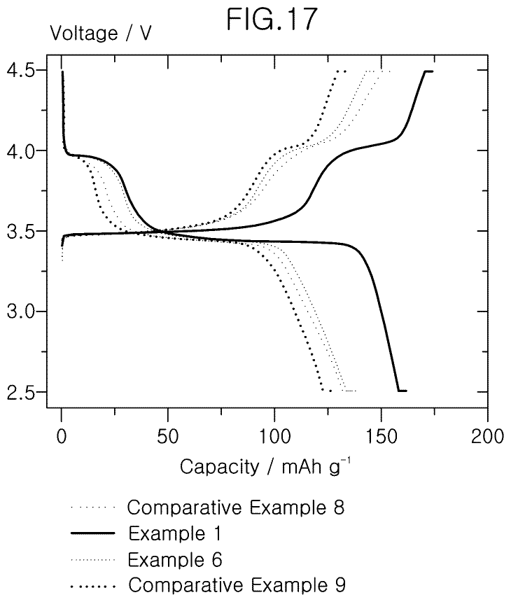

FIG. 17 is a graph showing results of measurement of voltage of Examples 1 and 6 and Comparative Examples 8 and 9, and Table 4 shows discharge capacity depending on the pH of the sol solution of Examples 1 and 6 and Comparative Examples 8 and 9.

Referring to FIG. 17 and Table 4, it was confirmed that Example 1, in which the pH of the sol solution was 2, and Example 6, in which the pH of the sol solution was 3, had excellent discharge capacity and voltage performance.

Additionally, when comparing Examples 1 and 6 with Comparative Examples 8 and 9, discharge capacity and voltage performance decreased with an increase or a decrease in the pH of the sol solution outside the range of 2 to 3. This confirmed that excellent discharge capacity and voltage performance were achieved when the pH of the sol solution was in the range of 2 to 3.

As is apparent from the above description, the present disclosure provides a cathode active material for a lithium secondary battery, including a first carbon coating layer formed on the surface of a core component containing lithium and configured to cover the core component and prevent dissolution of metal elements contained in the core component, and a second carbon coating layer formed on the surface of the first carbon coating layer and configured to have a lower carbon density and higher ionic conductivity than the first carbon coating layer, and a method of manufacturing the same.

The effects that may be obtained from the present disclosure are not limited to the effects mentioned above, and other effects not mentioned herein may be clearly understood by those skilled in the art from the description of the present disclosure.

Although specific embodiments of the present disclosure have been disclosed for illustrative purposes with reference to the appended drawings, the present disclosure is not limited thereto and is defined by the accompanying claims. Therefore, those skilled in the art will appreciate that various modifications and substitutions of the present disclosure are possible, without departing from the technical spirit of the accompanying claims.

What is claimed is:

1. A cathode active material for a lithium secondary battery, the cathode active material comprising:
a core component containing lithium;
a first carbon coating layer formed on a surface of the core component; and
a second carbon coating layer formed on a surface of core component the first carbon coating layer and configured to have a lower carbon density and higher ionic conductivity than the first carbon coating layer.

2. The cathode active material of claim 1, wherein the core component comprises a material represented by Chemical Formula 1 below:
Li(Fe_{1-x-y}MnₓM_{y})PO₄ [Chemical Formula 1]
wherein M comprises any one or a mixture of two or more selected from the group consisting of Al, Mg, Y, Zn, In, Ru, Sn, Sb, Ti, Te, Nb, Mo, Cr, Zr, W, Ir, V, and a combination thereof, 0≤x≤0.9, and 0≤y≤0.1.

3. The cathode active material of claim 1, wherein the first carbon coating layer covers about 70 to about 100% of the surface of the core component.

4. The cathode active material of claim 1, wherein a thickness of the first carbon coating layer is about 10 to about 50 nm.

5. The cathode active material of claim 1, wherein the second carbon coating layer covers about 30 to about 70% of the surface of the core component with the first carbon coating layer formed thereon.

6. The cathode active material of claim 1, wherein a thickness of the second carbon coating layer is about 100 to about 500 nm.

7. The cathode active material of claim 1, wherein an amount of the second carbon coating layer is about 5 to about 7 wt % based on a total of 100 wt % of the cathode active material.

8. The cathode active material of claim 1, wherein the second carbon coating layer comprises a conductive material.

9. The cathode active material of claim 8, wherein the conductive material is at least one selected from a conductive material group consisting of carbon black, CNTs, and mixtures thereof.

10. The cathode active material of claim 1, wherein a D/G ratio is 0.9 or higher when measured by Raman spectroscopy.

11. A method of manufacturing a cathode active material for a lithium secondary battery, the method comprising:
forming a core component containing lithium;
forming a first carbon coating layer on a surface of the core component; and
forming a second carbon coating layer on a surface of the first carbon coating layer, wherein the second carbon coating layer has a lower carbon density than the first carbon coating layer.

12. The method of claim 11, wherein a sol-gel method is used in forming the core component and forming the first carbon coating layer, and a pH of a solvent in the sol-gel method is 2 to 3.

13. The method of claim 11, wherein, in forming the first carbon coating layer, a first carbon coating solution comprising at least one organic material selected from the group consisting of sucrose, grape sugar, glucose, PEG2000, PEG6000, white sugar, and mixtures thereof is added to a solvent in a sol-gel method.

14. The method of claim 13, wherein the organic material is contained at a concentration of about 0.1 to about 0.2 M in the first carbon coating solution.

15. The method of claim 11, wherein, in forming the second carbon coating layer, a pitch is added in an amount of about 5 to about 7 wt % based on a total of the cathode active material.

16. The method of claim 11, wherein, in forming the second carbon coating layer, at least one selected from a conductive material group consisting of carbon black, CNTs, and mixtures thereof is added.

17. The method of claim 11, wherein forming the second carbon coating layer comprises adding the core component with the first carbon coating layer formed thereon, pitch carbon, and a conductive material to ethanol and performing milling.

18. The method of claim 11, wherein, in forming the second carbon coating layer, heat treatment is performed at 660 to 700° C.

19. An electrode for a lithium secondary battery comprising the cathode active material of claim 1.

20. A lithium secondary battery comprising the cathode active material of claim 1.
